(19) United States
(12) Patent Application Publication
(10) Pub. No.: US 2018/0003991 A1
(43) Pub. Date: Jan. 4, 2018

(54) IMAGE ALIGNMENT IN HEAD WORN DISPLAY

(71) Applicant: INTEL CORPORATION, SANTA CLARA, CA (US)

(72) Inventors: Mickael Guillaumee, Neuchatel (CH); Eric Tremblay, Saint Sulpice (CH)

(73) Assignee: INTEL CORPORATION, SANTA CLARA, CA (US)

(21) Appl. No.: 15/201,353

(22) Filed: Jul. 1, 2016

(51) Int. Cl. G02B 27/01; G06F 3/01

(52) U.S. Cl. CPC G02B 27/0179; G06F 3/013; G02B 27/0172; G02B 2027/0187

(57) ABSTRACT

Disclosed herein are devices and methods to ascertain, by way of a system, a change in eye focus from a first focus plane to a second focus plane. For example, the first focus plane of the eye may be infinity and the second focus plane of the eye may be less than infinity. The system may generate at least one light beam to accommodate the change in eye focus from the first focus plane to the second focus plane. In one example, the generated at least one light beam has an alignment, wavelength and/or modulation that is different than an alignment, wavelength and/or modulation of a prior light beam. The system may project a pixel on the eye using the at least one light beam.

### TECHNICAL FIELD

Embodiments herein generally relate to head worn displays (HWD) and heads up displays. More particularly, embodiments herein generally relate to image alignment and/or focusing for HWD implementations.

### BACKGROUND

Modern display technology may be implemented to provide head worn displays (HWD) and to see through the display and to see information (e.g., images, text, or the like) in conjunction with the see through display. Such displays can be implemented in a variety of contexts, for example, defense, transportation, industrial, entertainment, wearable devices, or the like.

In various HWD systems, an image may be reflected off a transparent projection surface to a user's eye to present an image in conjunction with a real worldview. HWDs provide a projection system and a lens that may include a holographic optical element (HOE). The projection system and the lens can be mounted to a frame to be worn by a user, for example, glasses, a helmet, or the like. During operation, the projection system projects an image onto an inside (e.g., proximate to the user) surface of the lens. The transparent projection surface reflects the image to an exit pupil (or viewpoint) or multiple exit pupils.

Multiple exit pupils may be spatially separated. The multiple exit pupils provide a projected virtual image that a user can perceive. The alignment of the multiple exit pupils is generally configured for a predetermined user focus. An undesirable spatial shift in the exit pupils may occur when a user deviates from the predetermined user focus. Such an undesirable spatial shift may cause blurring, double imaging, or misalignment of the projected virtual image.

### BRIEF DESCRIPTION OF THE DRAWINGS

FIG. 1 illustrates an example first system.

FIG. 2 illustrates an example second system.

FIG. 3 illustrates a portion of the example system in more detail.

FIG. 4 illustrates a portion of the example system in more detail.

FIG. 5 illustrates the lens of an eye focused at infinity.

FIG. 6 illustrates the lens of an eye focused at near or close.

FIG. 7 illustrates an example system or device.

FIG. 8 illustrates an example computer readable medium.

FIG. 9 illustrates an example logic flow.

### DETAILED DESCRIPTION

Various embodiments may generally be elements used with head worn displays (HWDs). HWDs may provide a projection system and a lens that includes a holographic optical element (HOE) or any other optical combining element. The projection system and the lens can be mounted to a frame to be worn by a user, for example, glasses, a helmet, or the like. During operation, the projection system projects an image onto an inside (e.g., proximate to the user) surface of the lens. The HOE reflects the image to an exit pupil (or viewpoint). Ideally, the exit pupil is proximate to one of the user's eyes, and specifically, to the pupil of the user's eye. As such, the user may perceive the reflected image.

Disclosed implementations provide image alignment for HWDs and the like. In one implementation, an HOE associated with an HWD may reflect two light beams toward a user's eye. The light beams are generated by a projection system associated with the HWD. Optimally, a first of the light beams and a second of the light beams will converge to a point on the retina of the user's eye. However, a focus change in the user's eye may cause the first and second light beams to cross or overlap before reaching the retina of the user's eye. This crossing or overlapping of the light beams may cause at least one pixel associated with the first and second light beams to generate undesirable blurring, double imaging, or misalignment of a projected virtual image associated with the pixels.

In one implementation, a focus detection element associated with a projection system may be used to ascertain that the user's eye has undergone a change from a first focal plane (e.g., infinity) to a second focal plane (e.g., a near focus point less than infinity). The focus detection element and the projection system may modify an alignment or wavelength of at least one of the first and second light beams to mitigate the blurring, double imaging, or misalignment of the projected virtual image associated with the pixels. In one implementation, the projection system is used with an HWD that uses an HOE.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, known structures and devices are shown in block diagram form in order to facilitate a description thereof. The intention is to provide a thorough description such that all modifications, equivalents, and alternatives within the scope of the claims are sufficiently described.

Additionally, reference may be made to variables, such as, “a”, “b”, “c”, which are used to denote components where more than one component may be implemented. It is important to note, that there need not necessarily be multiple components and further, where multiple components are implemented, they need not be identical. Instead, use of variables to reference components in the figures is done for convenience and clarity of presentation.

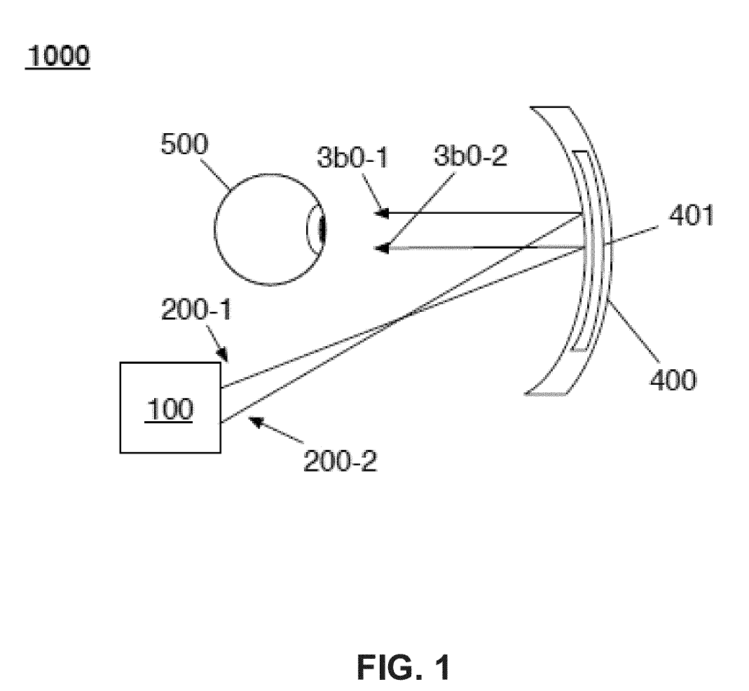

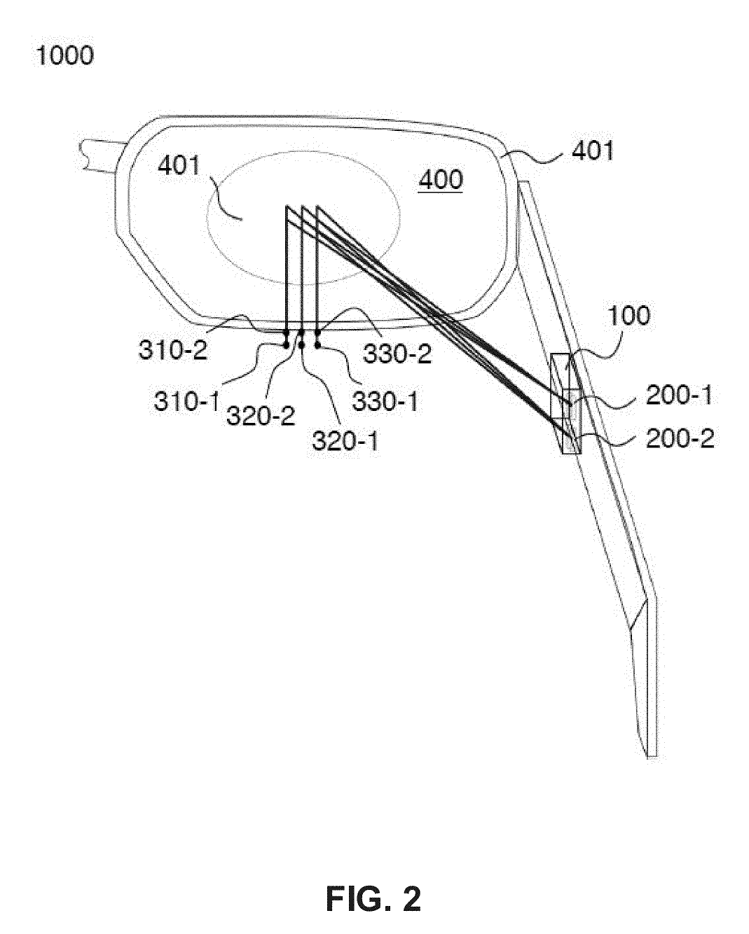

FIGS. 1-2 illustrate block diagrams of an optical system 1000 to provide multiple sets of exit pupils from multiple input pupils. It is noted, that FIG. 1 is a side view of the system 1000 while FIG. 2 is a perspective view of the system. Furthermore, it is noted that only the chief ray (described in greater detail below) is depicted in these figures for clarity of presentation.

In general, the system 1000 is configured to reflect light off a projection surface 400 to a user's eye 500. Said differently, the system 1000 projects a virtual image at exit pupils that are proximate to the user's eye 500 when a user is wearing and/or using the system 1000. In some implementations, the projection surface 400 is transparent, for example, to provide a real world view in conjunction with the projected virtual image. In some implementations, the projection surface 400 is opaque. In some implementations, the projection surface is partially transparent. It is noted, the projected virtual images can correspond to any information to be conveyed (e.g., text, images, or the like). Use of the term “virtual images” is not intended to be limiting to projection of images or pictures only. Furthermore, in some examples, the system 1000 can provide an augmented reality display where portions of the real world (e.g., either viewed through the display or projected) are augmented with virtual images. Examples are not limited in this context.

In general, the system 1000 is configured to create multiple spatially separated exit pupils at the eye 500 of the user of the system 1000 (or location where the eye should be or would be if the system 1000 were worn or used). However, the system 100 may also be configured to create a single exit pupil at the eye 500 of the user of the system 1000. Sets of spatially separated exit pupils form an enlarged “synthetic” eyebox. As such, a larger field of view or larger projected image may be provided by the system 1000. In addition to providing a larger field of view, the enlarged eyebox may account for both person-to-person anthropometric differences in eye location, and the rotation of a user's eye as the user explores the projected image. It is noted, in some examples, the system 1000 can provide an enlarged field of view to provide a larger projected virtual image. In some examples, the system 1000 can provide an enlarged field of view to provide multiple copies of a projected virtual image such that a user can perceive the projected virtual image as the user rotates the eye. Examples are not limited in this context.

In general, in FIG. 1, the system 1000 may include a projection system 100 to project light to form multiple entrance pupils 200-a, where a is a positive integer. In another implementation, the projection system 100 projects light to form a single entrance pupil. Light beams corresponding to entrance pupils 200-1 and 200-2 are depicted. Each of the light beams corresponding to the entrance pupils 200-a is wavelength-multiplexed to form multiple exit pupils 3b0-b for each entrance pupil, where b is a positive integer. As such, multiple sets of exit pupils are formed (e.g., one set for each entrance pupil 200-a). In another implementation, a single entrance pupil corresponds to a single exit pupil. Therefore, another embodiment may provide multiple entrance pupils, where each of the multiple entrance pupils corresponds to a single exit pupil. Wavelength multiplexing is not required in such an embodiment.

More specifically, the projection system 100 can project light from multiple entrance pupils 200-a to the projection surface 400. For example, the projection system can project light from entrance pupils 200-1 and 200-2 to the projection surface 400. Each entrance pupil 200-a includes multiple light beams, each having a different wavelength, but could also include a single light beam. The projection surface 400 reflects these wavelength multiplexed light beams to a first set of exit pupils 3b0-a. For example, the projection surface 400 can reflect the light beams from the entrance pupil 200-1 to the set of exit pupils 3b0-1 and the light beams from the entrance pupil 200-2 to the set of exit pupils 3b0-2. In particular, as depicted in FIG. 2, the projection surface 400 reflects light from entrance pupil 200-1 to exit pupils 310-1, 320-1, and 330-1. Additionally, the projection surface 400 reflects light from entrance pupil 200-2 to exit pupils 310-2, 320-2, and 330-2. Examples are not limited in this context.

In some implementations, each entrance pupil 200-a can correspond to a number of wavelength multiplexed light beams in a range of wavelengths. More specifically, the projection system 100 can project an input beam (e.g., 200-1, 200-2, or the like) including multiple groups of light, each group having a wavelength similar in perceived color (e.g., λ₁, λ₂, and λ₃) to the projection surface 400. Furthermore, the projection system 100 directs these wavelength-multiplexed light to the projection surface 400 from multiple spatially separated points.

In general, the projection surface 400 includes a number of independent, multiplexed gratings (e.g., Bragg gratings, or the like) recorded in it. The projection surface can be referred to as a HOE or a volume hologram. The projection surface 400 is wavelength selective, in that it reflects all (or at least part of) the light from a first wavelength (e.g., λ₁, first group of wavelengths, first range of wavelengths, or the like) to a first exit pupil location. The projection surface 400 reflects all (or at least part of) the light from a second wavelength (e.g., λ₂, second group of wavelengths, second range of wavelengths, or the like) to a second exit pupil location. The projection surface 400 reflects all (or at least part of) the light from a third wavelength (e.g., λ₃, third group of wavelengths, third range of wavelengths, or the like) to a third exit pupil location. These exit pupil locations are spatially separated from each other. Examples are not limited in this context.

For example, FIG. 2 depicts columns of exit pupils 3b0-a. In particular, a first column of exit pupils, which may correspond to a first wavelength can include exit pupils 310-1 and 310-2. A second column of exit pupils, which may correspond to a second wavelength can include exit pupils 320-1 and 320-2. A third column of exit pupils, which may correspond to a third wavelength can include exit pupils 330-1 and 330-2.

It is noted, that only the chief ray of the entrance and exit pupils are shown in FIGS. 1-2 and in FIG. 1, as the exit pupils for each input pupil are offset in the horizontal direction (or in-plane direction), they are not distinguished from each other. However, they are offset in the vertical (or out-of-plane direction). Accordingly, the 6 exit pupils 310-1, 310-2, 320-1, 320-2, 330-1, and 330-2 are depicted. In this example, the three wavelengths at which each input pupil are multiplexed act to spatially separate the exit pupils in the horizontal direction (3 across) with 3 multiplexed holograms 401 on the surface 400. The two entrance pupils 200-1 and 200-2 are used to create two rows of exit pupil. In particular, the leftmost column of the 3×2 exit pupil array would correspond to a single wavelength (λ₁) of light from two vertically offset sources. Similarly, for the middle column (λ₂ from two vertically offset sources) and right-most column (λ₃ from two vertically offset sources). Examples are not limited in this context.

Each of the entrance pupils are angularly separated from each other. It is noted, that HOE can be selective in angle and wavelength, however this property depends heavily on the orientation. In particular, such holograms can be highly selective in the plane perpendicular to the gratings (e.g., the Bragg direction, or the like). However, such holograms may be much less selective in the orthogonal or “out-of-plane” direction. Accordingly, the multiple entrance pupils are offset in the vertical direction of FIGS. 1-2 while the grating of the surface 400 is setup in the horizontal direction. It is noted, that the grating may be configured to wavelength multiplex the light either vertically or horizontally. As such, the entrance pupils may be either horizontally or vertically separated. It is worthy to note, the chief ray of the exit pupils 310-b corresponding to one entrance pupil 200-1 may not need to be aligned in a “line” as depicted in FIGS. 1-2. Examples are not limited in this respect. Examples are not limited in this context.

The projection system 100 projects light onto the projection surface 400 from the entrance pupils 200-a. In particular, the projection system 100 projects the light onto a portion of the projection surface 400 that includes the HOE 401. The HOE 401 reflects the incident light to multiple exit pupils 3b0-a to (or into) a user's eye 500 so a virtual image can be perceived by the user. Examples are not limited in this context.

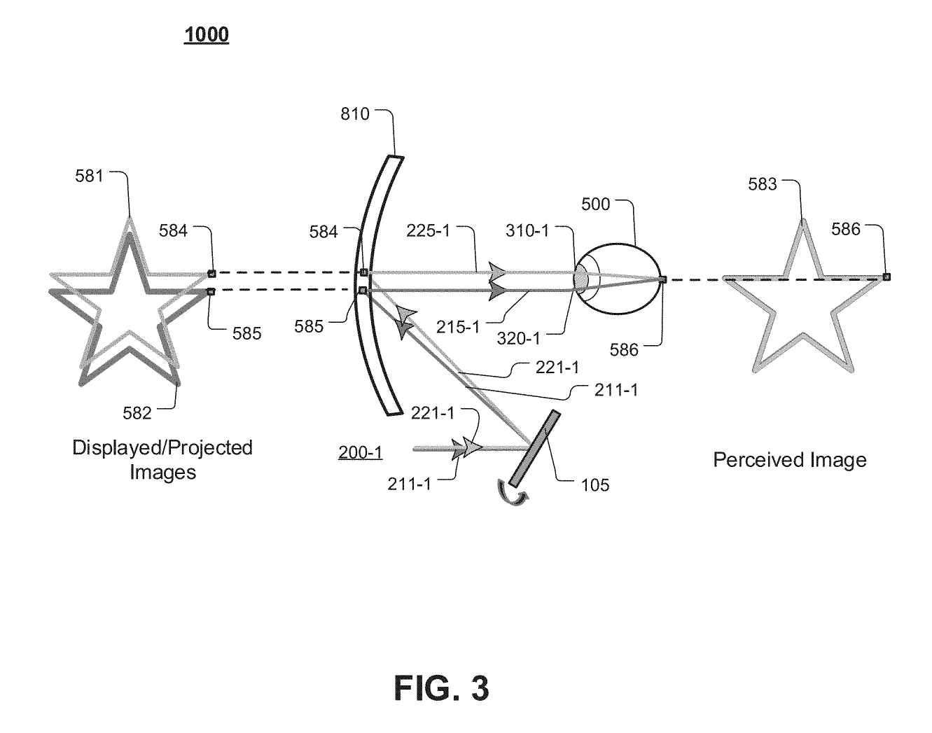

FIG. 3 depicts the scanning mirror 105 reflecting light beams 211-1 and 221-1 from entrance pupil 200-1. The light beams 211-1 and 221-1 can have different wavelengths as described above. The scanning mirror 105 reflects the light beams 211-1 and 221-1 to the projection surface 400, which includes a HOE to reflect the light beams to different exit pupils. The scanning mirror 105 (or other component of the projection system 100) can modulate the light beams 211-1 and 221-1 to correspond to images 581 and 582. By projecting images 581 and 582 shifted from each other as depicted, a single apparent image 583 can be produced on the retina of the eye 500. More specifically, a single image can be perceived by a user. Examples are not limited in this context.

In particular, the pixels 584 and 585 contain the information of the same image pixel for each exit pupil 310-1 and 320-1. By projecting pixels 584 and 585 on the projection surface with a separation distance similar to the separation distance of the exit pupils 310-1 and 320-1, pixels 584 and 585 are reflected by the projection surface 400 as diffracted light beams 215-1 and 225-1 to exit pupils 310-1 and 320-1, respectively. Additionally, the pixels 584 and 585 merge into one single pixel 586 on the retina of the eye 500 so the images 581 and 582 are perceived as a single image 583. This is true even when the eye 500 is rotated so the line of sight other than that illustrated in FIG. 3. Examples are not limited in this context.

In some examples, the light beams 211-1 and 221-1 are modulated based on image processing techniques to laterally shift the projected images for each of the different wavelength sources. Additional geometric corrections may be applied, for example, to correct for distortion. Furthermore, additional pre-processing of the images to correct nonlinearities (e.g., distortion, or the like) to improve alignment of the images may be implemented.

In some examples, multiple sets of light beams may be reflected off of the scanning mirror 105 to generate additional diffracted light beams, pixels, and corresponding exit pupils. Examples are not limited in this context.

In general, the projection system 100 can receive a beam of light from a laser or may include a laser to generate light beams having different wavelengths. The projection system 100 can include a micro-electro-mechanical system (MEMS) mirror to scan and/or direct the light across the projection surface 400 from multiple viewpoints (e.g., entrance pupils). Examples are not limited in this context.

With some examples, the projection surface 400 may be a volume holographic transflector. As noted, the projection surface 400 may reflect the light projected by the system 100 into the eye 500 to provide a virtual image in the synthetic eyebox. Additionally, the projection surface 400 can simultaneously allow light from outside the system 1000 (e.g., real world light, etc.) to be transmitted through the projection surface 400 to provide for a real world view in addition to a virtual view. Examples are not limited in this context.

In general, the system 1000 may be implemented in any heads up and/or head worn display. With some examples, the projection surface 400 may be implemented in a wearable device, such as for example, glasses 401. Although glasses are depicted, the system 1000 can be implemented in a helmet, visor, windshield, or other type of HUD/HWD display. Examples are not limited in this context.

Furthermore, additional sets of exit pupils can be created, for example, 3 entrance pupils each multiplexed with three wavelengths may form 9 exit pupils in a 3×3 array. Examples are not limited in this context.

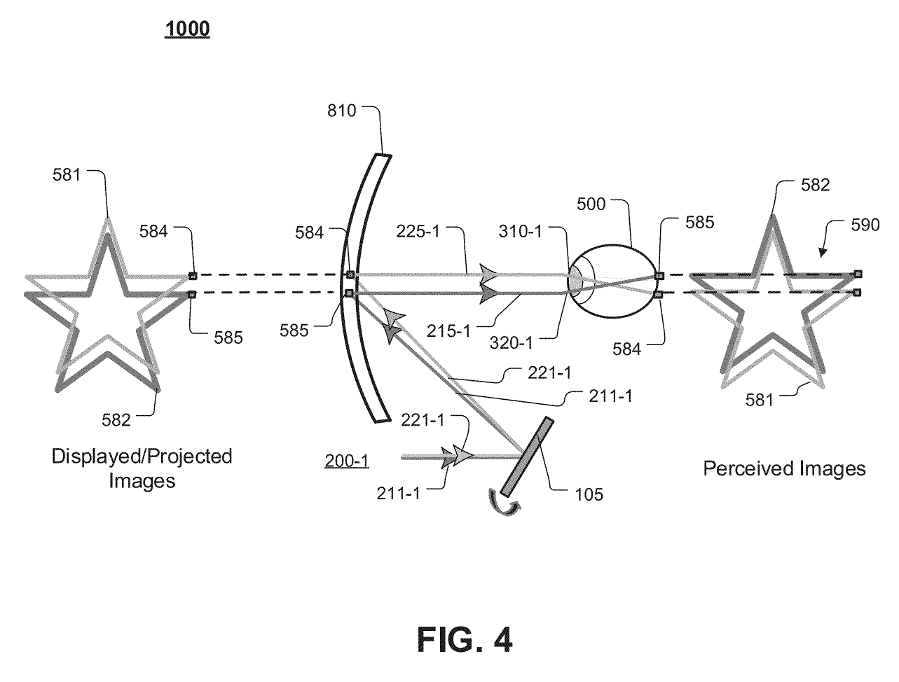

FIG. 4 depicts the scanning mirror 105 reflecting light beams 211-1 and 221-1 from entrance pupil 200-1. However, unlike the example illustrated in FIG. 3, the pixels 584 and 585 did not merge into one single pixel 586 on the retina of the eye 500 so that the images 581 and 582 are perceived as a single image. Rather, undesirably, the pixels 584 and 585 are separated on the retina of the eye 500 so that the images 581 and 582 are shifted, blurred or offset 590 as opposed to being merged as in the example illustrated in FIG. 3.

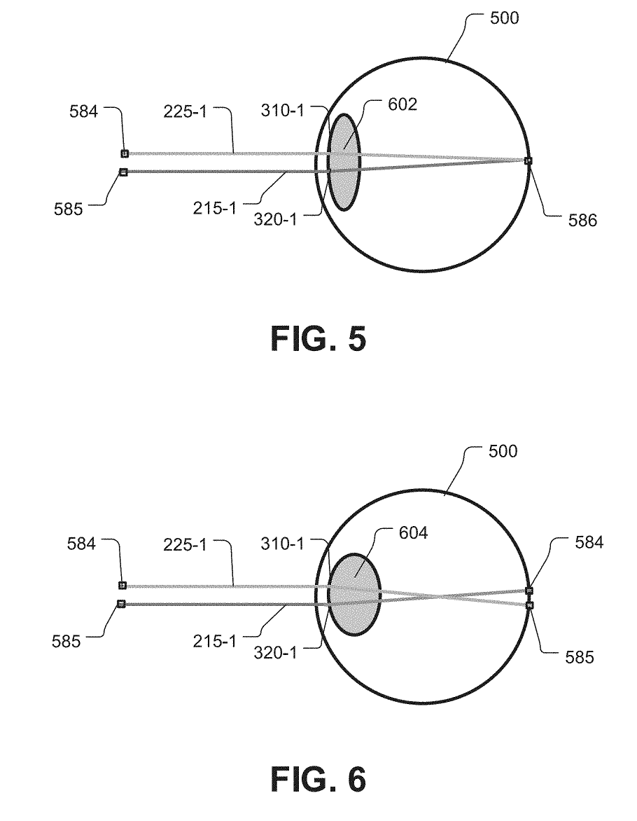

Conventionally, the light beams 211-1 and 221-1 and the corresponding pixels 584 and 585 are preprocessed to appear sharp or merged, as depicted in FIG. 3, when a user associated with the eye 500 focuses at a predetermined distance (e.g., a plane of focus at infinity or a near plane of focus). The image offset 590 illustrated in FIG. 4 may occur when the user associated with the eye 500 is focusing at a distance other than the predetermined distance. This function of the eye 500 is explained in greater detail in the following with reference to FIGS. 5-6.

The light beams 211-1 and 221-1 can have different wavelengths as described above. The scanning mirror 105 reflects the light beams 211-1 and 221-1 to the projection surface 400, which includes an HOE to reflect the light beams to different exit pupils. The scanning mirror 105 (or other component of the projection system 100) can modulate the light beams 211-1 and 221-1 to correspond to images 581 and 582. Examples are not limited in this context.

In particular, the pixels 584 and 585 contain the information of the same image pixel for each exit pupil 310-1 and 320-1. By projecting pixels 584 and 585 on the projection surface with a separation distance similar to the separation distance of the exit pupils 310-1 and 320-1, pixels 584 and 585 are reflected by the projection surface 400 as diffracted light beams 215-1 and 225-1 to exit pupils 310-1 and 320-1, respectively. Examples are not limited in this context.

In some examples, the light beams 211-1 and 221-1 are modulated based on image processing techniques to laterally shift the projected images for each of the different wavelength sources. Additional geometric corrections may be applied, for example, to correct for distortion. Furthermore, additional pre-processing of the images to correct nonlinearities (e.g., distortion, or the like) to improve alignment of the images may be implemented.

In some examples, multiple sets of light beams may be reflected off of the scanning mirror 105 to generate additional diffracted light beams, pixels, and corresponding exit pupils. Examples are not limited in this context.

In general, the projection system 100 can receive a beam of light from a laser or may include a laser to generate light beams having different wavelengths. The projection system 100 can include a micro-electro-mechanical system (MEMS) mirror to scan and/or direct the light across the projection surface 400 from multiple viewpoints (e.g., entrance pupils). Examples are not limited in this context.

With some examples, the projection surface 400 may be a volume holographic transflector. As noted, the projection surface 400 may reflect the light projected by the system 100 into the eye 500 to provide a virtual image in the synthetic eyebox. Additionally, the projection surface 400 can simultaneously allow light from outside the system 1000 (e.g., real world light, etc.) to be transmitted through the projection surface 400 to provide for a real world view in addition to a virtual view. Examples are not limited in this context.

In general, the system 1000 may be implemented in any heads up and/or head worn display. With some examples, the projection surface 400 may be implemented in a wearable device, such as for example, glasses 401. Although glasses are depicted, the system 1000 can be implemented in a helmet, visor, windshield, or other type of HUD/HWD display. Examples are not limited in this context.

Furthermore, additional sets of exit pupils can be created, for example, 3 entrance pupils each multiplexed with three wavelengths may form 9 exit pupils in a 3×3 array. Examples are not limited in this context.

FIG. 5 illustrates the eye 500, where a lens 602 of the eye 500 is relaxed such that the focus of the eye 500 is at infinity (e.g., the eye plane of focus is at infinity). Again, the pixels 584 and 585 contain the information of the same image pixel for each exit pupil 310-1 and 320-1. By projecting pixels 584 and 585 on the projection surface 400 (see FIGS. 3-4) with a separation distance similar to the separation distance of the exit pupils 310-1 and 320-1, pixels 584 and 585 are reflected by the projection surface 400 as diffracted light beams 215-1 and 225-1 to exit pupils 310-1 and 320-1, respectively. Additionally, the pixels 584 and 585 merge into one single pixel 586 on the retina of the eye 500. In this case, the light beams 211-1 and 221-1 and the corresponding pixels 584 and 585 were preprocessed to appear sharp or merged (e.g., the single pixel 586) when a user associated with the eye 500 focuses at infinity. Examples are not limited in this context.

FIG. 6 illustrates the eye 500, where a lens 604 of the eye is changed (e.g., made more spherical) by the ciliary muscles of the eye 500 such that the focus of the eye 500 is on one or more near object (e.g., the plane of focus is less than infinity). Again, the pixels 584 and 585 contain the information of the same image pixel for each exit pupil 310-1 and 320-1. By projecting pixels 584 and 585 on the projection surface 400 (see FIGS. 3-4) with a separation distance similar to the separation distance of the exit pupils 310-1 and 320-1, pixels 584 and 585 are reflected by the projection surface 400 as diffracted light beams 215-1 and 225-1 to exit pupils 310-1 and 320-1, respectively. However, in this case the pixels 584 and 585 do not merge into one single pixel 586 on the retina of the eye 500. This is because the light beams 211-1 and 221-1 and the corresponding pixels 584 and 585 were preprocessed to appear sharp or merged (e.g., the single pixel 586) when a user associated with the eye 500 focuses at infinity, rather than when the eye focuses on near objects. Undesirably, the pixels 584 and 585 are separated on the retina of the eye 500 so that the pixels 584 and 585 are shifted, blurred or offset as opposed to being merged as in the example illustrated in FIG. 5. Examples are not limited in this context.

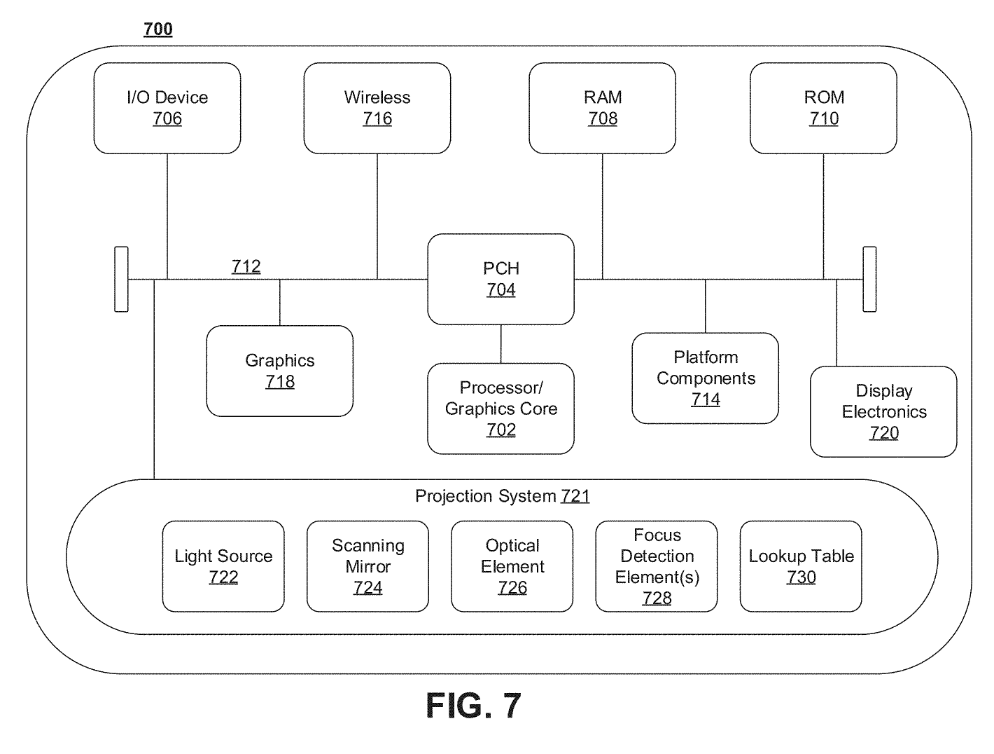

FIG. 7 depicts that a platform (system) 700 may include a processor/graphics core 702, a chipset/platform control hub (PCH) 704, an input/output (I/O) device 706, a random access memory (RAM) (such as dynamic RAM (DRAM)) 708, and a read only memory (ROM) 710, display electronics 720, projection system 721 (e.g., the projection system 100), and various other platform components 714 (e.g., a fan, a cross flow blower, a heat sink, DTM system, cooling system, housing, vents, and so forth). System 700 may also include wireless communications chip 716 and graphics device 718. The embodiments, however, are not limited to these elements. The system 700 may be coupled to the system 1000 and/or implemented by the system 1000. Examples are not limited in this context.

As depicted, I/O device 706, RAM 708, and ROM 710 are coupled to processor 702 by way of chipset 704. Chipset 704 may be coupled to processor 702 by a bus 712. Accordingly, bus 712 may include multiple lines.

Processor 702 may be a central processing unit comprising one or more processor cores and may include any number of processors having any number of processor cores. The processor 702 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 702 may be multiple separate processors located on separate integrated circuit chips. In some embodiments processor 702 may be a processor having integrated graphics, while in other embodiments processor 702 may be a graphics core or cores. Examples are not limited in this context.

The projection system 721 may include various elements that aid in providing light as part of generating pixels (e.g., pixels 584 and 585). Furthermore, the projection system 721 may include various elements to mitigate shifting, blurring or offset of pixels as a result of eye focus change. The elements of the projection system 721 may be controlled by a controller, such as the processor/graphics core 702. The projection system 721 may include one or more light source 722, one or more scanning mirror 724, one or more optical element 726, one or more focused detection element 728, and a lookup table 730. In general, the light source 722 emits light having multiple light beams (e.g., light beams 211-1 and 221-1 from entrance pupil 200-1). The light beams may have different wavelengths. The light beams emitted from the light source 722 may be received by the one or more scanning mirror 724. The one or more scanning mirror 724 may project the light beams into an optical element 726. The optical element 726 directs (e.g. reflects, diffracts, folds, and/or the like) the light beams to a projection surface (e.g. the projection surface 400) from one or more entrance pupil. For example, the optical element 726 may direct light beams 211-1 and 221-1 from entrance pupil 200-1. Examples are not limited in this context.

Typically, systems like the systems 100, 700 and/or 1000 have been implemented with a fixed point of focus for presenting light beams and associated pixels. This can cause conflicts, blurring, shifting or visual miscues when the fixed focus of the light beams and associated pixels is set, but other depth cues (e.g., vergence, shadows, etc.) cause a user to perceive the light beams and associated pixels while the eye (e.g., eye 500) deviates or changes to a focal point, or plane of focus, that is different from the fixed point of focus for presenting the light beams and associated pixels. In addition, vergence and accommodation in the eye may also be a source of blurring, shifting or visual miscues associated with the fixed focus of the light beams and associated pixels. Vergence, for instance, is the movement of eyes to move an object of attention into the fovea of the retinas. Accommodation, for instance, is the process by which the eye changes optical power to create a clear foveal image in focus, much like focusing a camera lens.

The one or more of focus detection element 728 may be provided for gaze tracking in order to determine, generally, a field of view, focus distance, and/or focus plane of the eye 500. The one or more focus detection element 728 is functional to determine generally a field of view, focus distance, and/or focus plane associated with a plurality of eyes as well. Therefore, the one or more focus detection element 728 may employ one or more camera, one or more sensor, or the like, to determine a point of eye focus or attention by tracking a gaze of the eye 500, to determine a field of view, focus distance, and/or focus plane based on gaze tracking information. In general, the focus detection element 728 is capable of determining when a field of view, focus distance and/or focus plan of the eye 500 changes. Examples are not limited in this context.

The focus detection element 728 may interface with the processor/graphics core 702, RAM 708, ROM 710, and the like, to implement, maintain and augment a depth buffer of information data and/or objects (e.g., physical and/or virtual) associated in at least one scene within a field of view of the system 1000. Therefore, the focus detection element 728 may employ the one or more camera to provide information to the depth buffer. Gaze tracking information ascertained by the focus detection element 728 may be matched against the depth buffer to determine a focus distance or focus plane (e.g., near, intermediate, or far) of the eye 500. Examples are not limited in this context.

The determined focus distance (e.g., near, intermediate, or far) of the eye 500 may cause the focus detection element 728 to adjust one or more of the light beams 211-1 and 221-1 from entrance pupil 200-1 to accommodate that the eye 500 has made a focus change. The adjustment to one or more of the light beams 211-1 and 221-1 may provide that the corresponding pixels 584 and 585 that were preprocessed to appear sharp or merged (e.g., the single pixel 586) when a user associated with the eye 500 focuses at infinity, now appear sharp or merged at near an intermediate focal point or plane of focus. In one implementation, the focus detection element 728 may monitor the focus distance of the eye 500 in substantially real-time, continuously, periodically, according to a schedule, on demand, and so forth. As such, as the eye 500 changes focus or gaze, the system 1000 and the focus detection element 728 may dynamically adjust the light beams 211-1 and 221-1, and the corresponding pixels 584 and 585, to accommodate for varying focus distances and focus changes of the eye 500. Examples are not limited in this context.

The lookup table 730 may store one or more light beam compensation value and an associated focus distance for each of the one or more light beam compensation values. For example, a first stored light beam compensation value may be referenced by the focus detection element 728 when it is detected that the eye 500 changes focus from infinity to near. Further, a second stored light beam compensation value may be referenced by the focus detection element 728 when it is detected that the eye changes focus from infinity to a first intermediate focus range. In addition, a third stored light beam compensation value may be referenced by the focus detection element 728 when it is detected that the eye changes focus from infinity to a second intermediate focus range. The first intermediate focus range and the second intermediate focus range may be different. Additional light beam compensation values and associated focus distances may be stored in the lookup table 730. In general, the stored light beam compensation values (e.g., light beam adjustment information) may be used to dynamically adjust the light beams 211-1 and 221-1 as the eye 500 changes focus. The focus distance associated with each of the one or more light beam compensation value enable rapid searching of the lookup table 730 by the system 1000, projection system 721, and/or the focus detection element 728. Examples are not limited in this context.

In one implementation, based on a determined focus of the eye 500, the focus detection element 728 may adjust one or more of the light beams 211-1 and 221-1 to provide the single pixel 586. In another implementation, based on a determined focus of the eye 500, the focus detection element 728 may adjust both of the light beams 211-1 and 221-1 to provide the single pixel 586. In one example, an alignment associated with one or more of the light beams 211-1 and 221-1 is adjusted to provide the single pixel 586. In another example, an alignment associated with both of the light beams 211-1 and 221-1 is adjusted to provide the single pixel 586. The focus detection element 728 may adjust the reflective properties or attributes of the optical element at 726 to achieve the aforementioned beam alignment compensations. Furthermore, the focus detection element 728 may access the lookup table 730 and retrieve stored one or more light beam compensation values to enable alignment adjustment of the one or more of the light beams 211-1 and 221-1. Examples are not limited in this context.

Further to the foregoing, in one example, a wavelength associated with one or more of the light beams 211-1 and 221-1 is adjusted to provide the single pixel 586. In another example, a wavelength associated with both of the light beams 211-1 and 221-1 is adjusted to provide the single pixel 586. The focus detection element 728 may adjust the light produced by the light source 722 to achieve the aforementioned wavelength compensations. Furthermore, the focus detection element 728 may access the lookup table 730 and retrieve stored one or more light beam compensation values to enable wavelength adjustment of the one or more of the light beams 211-1 and 221-1. In a similar manner, a modulation associated with one or more of the light beams 211-1 and 221-1 may be adjusted to provide the single pixel 586. Examples are not limited in this context.

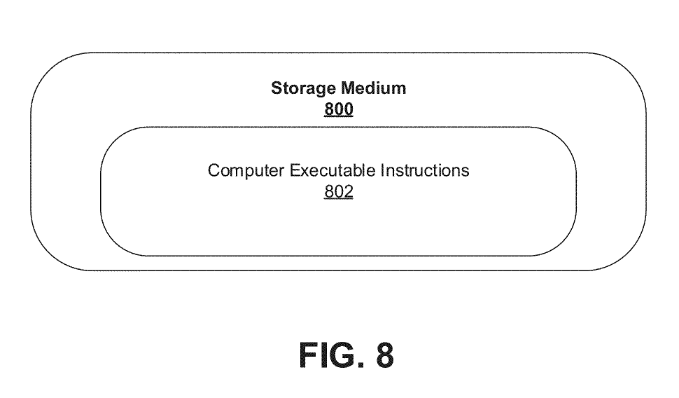

FIG. 8 illustrates an embodiment of a storage medium 800. The storage medium 800 may comprise an article of manufacture. In some examples, the storage medium 800 may include any non-transitory computer readable medium or machine readable medium, such as an optical, magnetic or semiconductor storage. The storage medium 800 may store various types of computer executable instructions e.g., 802). For example, the storage medium 800 may store various types of computer executable instructions to implement the dynamic one or more light beam, and associated one or more pixel, compensation techniques described herein. The storage medium 800 may be coupled to one or more of the systems 100, 1000 and 700. For example, when coupled to the one or more systems, the computer executable instructions 802 may be executed by the one or more systems to aid in performing one or more techniques described herein (e.g., dynamic one or more light beam, and associated one or more pixel, compensation techniques). Furthermore, the storage medium 800 may store other information related to the light beam compensation associated with HWDs.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

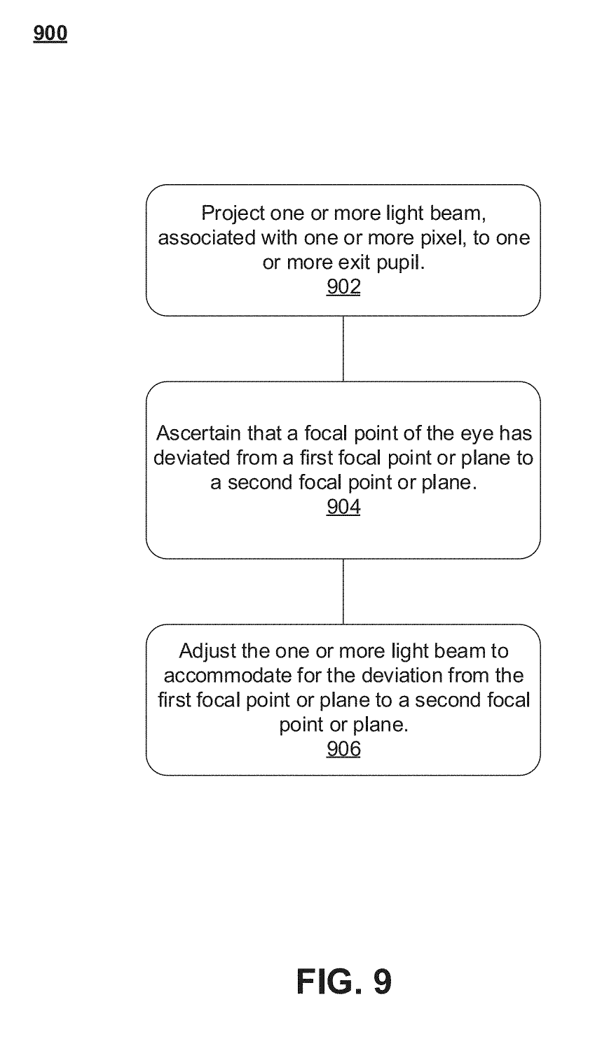

FIG. 9 illustrates a logic flow 900. In one implementation, the storage medium 800 may store various types of computer executable instructions to implement technique 900. For example, the computer executable instructions 802 may be used to implement the technique 900. In general, the computer executable instructions 802 may be provided to implement the image and a light beam compensation and alignment techniques described in the foregoing and hereinafter.

At block 902, a system, such as the system 100, system 1000, and/or system 700, projects one or more light beam (e.g., images 211-1 and/or 221-1), associated with one or more pixel (e.g., 584 and 585), onto a scanning mirror (e.g., scanning mirror 105). The scanning mirror reflects the one or more light beam to a projection service (e.g., projection surface 400). The projection surface may include an HOE to reflect the one or more light beam to one or more exit pupil. In one example, the one or more light beam comprises a plurality of light beams, were a first light beam corresponds to a first image (e.g., image 581) and a second light beam corresponds to a second image (e.g., image 582). The first and second light beams enter an eye (e.g., eye 500). The lens of the eye causes the first and second light beams to converge to a single point (e.g., point 586) on the retina of the eye. In one example, the first light beam is associated with a first pixel (e.g., pixel 584) and a second light beam is associated with a second pixel (e.g., pixel 585). An image associated with the first and second pixels will be properly displayed if the first and second pixels converge to a single pixel (e.g., single pixel 586) on the retina of the eye.

At block 904, the system ascertains that a focal point or plane of focus of the eye 500 has deviated from a first focal point or plane to a second focal point or plane. In one example, the first focal point or plane is infinity and the second focal point or plane is a focal point or plane less than infinity. In another example, the first focal point or plane is less than infinity and the second focal point or plane is infinity. In one implementation, the one or more light beam is reflected and/or modulated assuming that the eye is focused at the first focal point for plane (e.g., a predetermined focal point or plane). Therefore, without compensation, the one or more light beam would not properly render a merged image on the retina of the eye.

At block 906, the system adjusts the one or more light beam to accommodate for the deviation from the first focal point or plane to a second focal point or plane, determined at block 904. In one implementation, an alignment associated with the one or more of the light beam is adjusted to provide a converged single pixel on the retina. In another implementation, a wavelength associated with the one or more light beam is adjusted to provide a converged single pixel on the retina. In another implementation, a modulation associated with the one or more light beam is adjusted to provide a converged single pixel on the retina.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

### Example 1

An image alignment method, comprising: ascertaining, by way of a projection system, a change in eye focus from a first focus plane to a second focus plane; generating, by way of the projection system, at least one light beam to accommodate the change in eye focus from the first focus plane to the second focus plane; and projecting, by way of the projection system, at least one pixel on the eye using the at least one light beam.

### Example 2

The method according to Example 1, wherein generating the at least one light beam to accommodate the change in eye focus from the first focus plane to the second focus plane comprises generating at least a first light beam and a second light beam, and projecting the at least one pixel on the eye comprises projecting at least a first pixel and a second pixel on the eye, the first pixel associated with the first light beam and the second pixel associated with the second light beam.

### Example 3

The method according to Example 1, wherein the first focus plane is an infinity focus plane of the eye and the second focus plane is at least less than the infinity focus plane of the eye.

### Example 4

The method according to Example 1, wherein the first focus plane is less than an infinity focus plane of the eye and the second focus plane is the infinity focus plane of the eye.

### Example 5

The method according to Example 1, comprising generating, by way of the projection system, a prior light beam before generating the at least one light beam, the at least one light beam is an eye focus compensated light beam of the prior light beam.

### Example 6

The method according to Example 1, comprising generating the at least one light beam to have a beam alignment that is different than a beam alignment of a prior light beam.

### Example 7

The method according to Example 6, comprising referencing, by way of the projection system, a lookup table to retrieve a beam compensation value to enable the beam alignment of the at least one light beam.

### Example 8

The method according to Example 1, comprising generating the at least one light beam to have a wavelength that is different than a prior wavelength of a prior light beam.

### Example 9

The method according to Example 8, comprising referencing, by way of the projection system, a lookup table to retrieve the wavelength.

### Example 10

At least one non-transitory machine-readable storage medium comprising instructions that when executed by a computing device, cause the computing device to: ascertain a change in eye focus from a first focus plane to a second focus plane; generate at least one light beam to accommodate the change in eye focus from the first focus plane to the second focus plane; and project a pixel on the eye using the at least one light beam.

### Example 11

The least one non-transitory machine-readable storage medium of Example 10, wherein the instructions, when executed by the computing device, cause the computing device to generate at least two light beams to accommodate the change in eye focus from the first focus plane to the second focus plane, and the projecting act projects at least two pixels on the eye, a first of the least two pixels associated with a first of the at least two light beams and a second of the at least two pixels associated with a second of the at least two light beams.

### Example 12

The least one non-transitory machine-readable storage medium of Example 10, wherein the instructions, when executed by the computing device, cause the computing device to generate a prior light beam before the instructions generate the at least one light beam, the at least one light beam is an eye focus compensated light beam of the prior light beam.

### Example 13

The least one non-transitory machine-readable storage medium of Example 10, wherein the instructions to generate the at least one light beam include instructions to generate the at least one light beam having a beam alignment that is different than a beam alignment of a prior light beam.

### Example 14

The least one non-transitory machine-readable storage medium of Example 13, wherein the instructions, when executed by the computing device, cause the computing device to reference a lookup table to retrieve a beam compensation value to enable the beam alignment of the at least one light beam.

### Example 15

The least one non-transitory machine-readable storage medium of Example 10, wherein the instructions to generate the at least one light beam include instructions to generate the at least one light beam having a wavelength that is different than a prior wavelength of a prior light beam.

### Example 16

The least one non-transitory machine-readable storage medium of Example 15, wherein the instructions, when executed by the computing device, cause the computing device to reference a lookup table to retrieve the wavelength.

### Example 17

An apparatus, comprising: at least one memory; and a processor circuit coupled to the at least one memory, the processor circuit to: ascertain a change in eye focus from a first focus plane to a second focus plane; generate at least one light beam to accommodate the change in eye focus from the first focus plane to the second focus plane; and project a pixel on the eye using the at least one light beam.

### Example 18

The apparatus according to Example 17, wherein the processor circuit is to generate at least two light beams to accommodate the change in eye focus from the first focus plane to the second focus plane, and project at least two pixels on the eye, a first of the least two pixels associated with a first of the at least two light beams and a second of the at least two pixels associated with a second of the at least two light beams.

### Example 19

The apparatus according to Example 17, wherein the processor circuit is to generate a prior light beam before the processor circuit generates the at least one light beam, the at least one light beam is an eye focus compensated light beam of the prior light beam.

### Example 20

The apparatus according to Example 17, wherein the at least one light beam has a beam alignment that is different than a beam alignment of a prior light beam.

### Example 21

The apparatus according to Example 20, wherein the processor circuit is to reference a lookup table to retrieve a beam compensation value to enable the beam alignment of the at least one light beam.

### Example 22

An apparatus, comprising: at least one light source to generate a first light beam and a second light beam, the first light beam and the second light beam provided for a predetermined focus plane of an eye; and a focus detection element to: determine a focus plane of the eye has deviated from the predetermined focus plane of the eye; and adjust at least one of the first and second light beams based the determination that the focus plane of the eye has deviated from the predetermined focus plane of the eye.

### Example 23

The apparatus according to Example 22, wherein the focus detection element is to adjust a beam alignment of the at least one of the first and second light beams.

### Example 24

The apparatus according to Example 22, wherein the focus detection element is to adjust an alignment of the first light beam and an alignment of the second light beam.

### Example 25

The apparatus according to Example 22, wherein the focus detection element is to retrieve light beam adjustment information from a lookup table to adjust the at least one of the first and second light beams.

### Example 26

An image alignment method, comprising: ascertaining, by way of a projection system, a change in eye focus from a first focus plane to a second focus plane; generating, by way of the projection system, at least one light beam to accommodate the change in eye focus from the first focus plane to the second focus plane; and projecting, by way of the projection system, at least one pixel on the eye using the at least one light beam.

### Example 27

The method according to Example 26, wherein generating the at least one light beam to accommodate the change in eye focus from the first focus plane to the second focus plane comprises generating at least a first light beam and a second light beam, and projecting the at least one pixel on the eye comprises projecting at least a first pixel and a second pixel on the eye, the first pixel associated with the first light beam and the second pixel associated with the second light beam.

### Example 28

The method according to any of Examples 26 to 27, wherein the first focus plane is an infinity focus plane of the eye and the second focus plane is at least less than the infinity focus plane of the eye.

### Example 29

The method according to any of Examples 26 to 27, wherein the first focus plane is less than an infinity focus plane of the eye and the second focus plane is the infinity focus plane of the eye.

### Example 30

The method according to any of Examples 26 to 27, comprising generating, by way of the projection system, a prior light beam before generating the at least one light beam, the at least one light beam is an eye focus compensated light beam of the prior light beam.

### Example 31

The method according to any of Examples 26 to 27, comprising generating the at least one light beam to have a beam alignment that is different than a beam alignment of a prior light beam.

### Example 32

The method according to Example 31, comprising referencing, by way of the projection system, a lookup table to retrieve a beam compensation value to enable the beam alignment of the at least one light beam.

### Example 33

The method according to any of Examples 26 to 27, comprising generating the at least one light beam to have a wavelength that is different than a prior wavelength of a prior light beam.

### Example 34

The method according to Example 33, comprising referencing, by way of the projection system, a lookup table to retrieve the wavelength.

### Example 35

At least one non-transitory machine-readable storage medium comprising instructions that when executed by a computing device, cause the computing device to: ascertain a change in eye focus from a first focus plane to a second focus plane; generate at least one light beam to accommodate the change in eye focus from the first focus plane to the second focus plane; and project a pixel on the eye using the at least one light beam.

### Example 36

The least one non-transitory machine-readable storage medium of Example 35, wherein the instructions, when executed by the computing device, cause the computing device to generate at least two light beams to accommodate the change in eye focus from the first focus plane to the second focus plane, and the projecting act projects at least two pixels on the eye, a first of the least two pixels associated with a first of the at least two light beams and a second of the at least two pixels associated with a second of the at least two light beams.

### Example 37

The least one non-transitory machine-readable storage medium according to any of Examples 35 to 36, wherein the instructions, when executed by the computing device, cause the computing device to generate a prior light beam before the instructions generate the at least one light beam, the at least one light beam is an eye focus compensated light beam of the prior light beam.

### Example 38

The least one non-transitory machine-readable storage medium according to any of Examples 35 to 36, wherein the instructions to generate the at least one light beam include instructions to generate the at least one light beam having a beam alignment that is different than a beam alignment of a prior light beam.

### Example 39

The least one non-transitory machine-readable storage medium of Example 38, wherein the instructions, when executed by the computing device, cause the computing device to reference a lookup table to retrieve a beam compensation value to enable the beam alignment of the at least one light beam.

### Example 40

The least one non-transitory machine-readable storage medium according to any of Examples 35 to 36, wherein the instructions to generate the at least one light beam include instructions to generate the at least one light beam having a wavelength that is different than a prior wavelength of a prior light beam.

### Example 41

The least one non-transitory machine-readable storage medium of Example 40, wherein the instructions, when executed by the computing device, cause the computing device to reference a lookup table to retrieve the wavelength.

### Example 42

An apparatus, comprising: at least one memory; and a processor circuit coupled to the at least one memory, the processor circuit to: ascertain a change in eye focus from a first focus plane to a second focus plane; generate at least one light beam to accommodate the change in eye focus from the first focus plane to the second focus plane; and project a pixel on the eye using the at least one light beam.

### Example 43

The apparatus according to Example 41, wherein the processor circuit is to generate at least two light beams to accommodate the change in eye focus from the first focus plane to the second focus plane, and project at least two pixels on the eye, a first of the least two pixels associated with a first of the at least two light beams and a second of the at least two pixels associated with a second of the at least two light beams.

### Example 44

The apparatus according to any of Examples 42 to 43, wherein the processor circuit is to generate a prior light beam before the processor circuit generates the at least one light beam, the at least one light beam is an eye focus compensated light beam of the prior light beam.

### Example 45

The apparatus according to any of Examples 42 to 43, wherein the at least one light beam has a beam alignment that is different than a beam alignment of a prior light beam.

### Example 46

The apparatus according to Example 45, wherein the processor circuit is to reference a lookup table to retrieve a beam compensation value to enable the beam alignment of the at least one light beam.

### Example 47

An apparatus, comprising: means to generate a first light beam and a second light beam, the first light beam and the second light beam provided for a predetermined focus plane of an eye; and means to: determine a focus plane of the eye has deviated from the predetermined focus plane of the eye; and adjust at least one of the first and second light beams based the determination that the focus plane of the eye has deviated from the predetermined focus plane of the eye.

### Example 48

The apparatus according to Example 47, wherein the means to determine and adjust is to adjust a beam alignment of the at least one of the first and second light beams.

### Example 49

The apparatus according to Example 47, wherein the means to determine and adjust is to adjust an alignment of the first light beam and an alignment of the second light beam.

### Example 50

The apparatus according to Example 47, wherein the means to determine and adjust is to retrieve light beam adjustment information from a lookup table to adjust the at least one of the first and second light beams.

### Example 51

An apparatus, comprising: at least one light source to generate a first light beam and a second light beam, the first light beam and the second light beam provided for a predetermined focus plane of an eye; and a focus detection element to: determine a focus plane of the eye has deviated from the predetermined focus plane of the eye; and adjust at least one of the first and second light beams based the determination that the focus plane of the eye has deviated from the predetermined focus plane of the eye.

### Example 52

The apparatus according to Example 51, wherein the focus detection element is to adjust a beam alignment of the at least one of the first and second light beams.

### Example 53

The apparatus according to Example 51, wherein the focus detection element is to adjust an alignment of the first light beam and an alignment of the second light beam.

### Example 54

The apparatus according to Example 51, wherein the focus detection element is to retrieve light beam adjustment information from a lookup table to adjust the at least one of the first and second light beams.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An image alignment method, comprising:
ascertaining, by way of a projection system, a change in eye focus from a first focus plane to a second focus plane;
generating, by way of the projection system, at least one light beam to accommodate the change in eye focus from the first focus plane to the second focus plane; and
projecting, by way of the projection system, at least one pixel on the eye using the at least one light beam.

2. The method according to claim 1, wherein generating the at least one light beam to accommodate the change in eye focus from the first focus plane to the second focus plane comprises generating at least a first light beam and a second light beam, and projecting the at least one pixel on the eye comprises projecting at least a first pixel and a second pixel on the eye, the first pixel associated with the first light beam and the second pixel associated with the second light beam.

3. The method according to claim 1, wherein the first focus plane is an infinity focus plane of the eye and the second focus plane is at least less than the infinity focus plane of the eye.

4. The method according to claim 1, wherein the first focus plane is less than an infinity focus plane of the eye and the second focus plane is the infinity focus plane of the eye.

5. The method according to claim 1, comprising generating, by way of the projection system, a prior light beam before generating the at least one light beam, the at least one light beam is an eye focus compensated light beam of the prior light beam.

6. The method according to claim 1, comprising generating the at least one light beam to have a beam alignment that is different than a beam alignment of a prior light beam.

7. The method according to claim 6, comprising referencing, by way of the projection system, a lookup table to retrieve a beam compensation value to enable the beam alignment of the at least one light beam.

8. The method according to claim 1, comprising generating the at least one light beam to have a wavelength that is different than a prior wavelength of a prior light beam.

9. The method according to claim 8, comprising referencing, by way of the projection system, a lookup table to retrieve the wavelength.

10. At least one non-transitory machine-readable storage medium comprising instructions that when executed by a computing device, cause the computing device to:
ascertain a change in eye focus from a first focus plane to a second focus plane;
generate at least one light beam to accommodate the change in eye focus from the first focus plane to the second focus plane; and
project a pixel on the eye using the at least one light beam.

11. The least one non-transitory machine-readable storage medium of claim 10, wherein the instructions, when executed by the computing device, cause the computing device to generate at least two light beams to accommodate the change in eye focus from the first focus plane to the second focus plane, and the projecting act projects at least two pixels on the eye, a first of the least two pixels associated with a first of the at least two light beams and a second of the at least two pixels associated with a second of the at least two light beams.

12. The least one non-transitory machine-readable storage medium of claim 10, wherein the instructions, when executed by the computing device, cause the computing device to generate a prior light beam before the instructions generate the at least one light beam, the at least one light beam is an eye focus compensated light beam of the prior light beam.

13. The least one non-transitory machine-readable storage medium of claim 10, wherein the instructions to generate the at least one light beam include instructions to generate the at least one light beam having a beam alignment that is different than a beam alignment of a prior light beam.

14. The least one non-transitory machine-readable storage medium of claim 13, wherein the instructions, when executed by the computing device, cause the computing device to reference a lookup table to retrieve a beam compensation value to enable the beam alignment of the at least one light beam.

15. The least one non-transitory machine-readable storage medium of claim 10, wherein the instructions to generate the at least one light beam include instructions to generate the at least one light beam having a wavelength that is different than a prior wavelength of a prior light beam.

16. The least one non-transitory machine-readable storage medium of claim 15, wherein the instructions, when executed by the computing device, cause the computing device to reference a lookup table to retrieve the wavelength.

17. An apparatus, comprising:
at least one memory; and
a processor circuit coupled to the at least one memory, the processor circuit to:
ascertain a change in eye focus from a first focus plane to a second focus plane;
generate at least one light beam to accommodate the change in eye focus from the first focus plane to the second focus plane; and
project a pixel on the eye using the at least one light beam.

18. The apparatus according to claim 17, wherein the processor circuit is to generate at least two light beams to accommodate the change in eye focus from the first focus plane to the second focus plane, and project at least two pixels on the eye, a first of the least two pixels associated with a first of the at least two light beams and a second of the at least two pixels associated with a second of the at least two light beams.

19. The apparatus according to claim 17, wherein the processor circuit is to generate a prior light beam before the processor circuit generates the at least one light beam, the at least one light beam is an eye focus compensated light beam of the prior light beam.

20. The apparatus according to claim 17, wherein the at least one light beam has a beam alignment that is different than a beam alignment of a prior light beam.

21. The apparatus according to claim 20, wherein the processor circuit is to reference a lookup table to retrieve a beam compensation value to enable the beam alignment of the at least one light beam.

22. An apparatus, comprising:
at least one light source to generate a first light beam and a second light beam, the first light beam and the second light beam provided for a predetermined focus plane of an eye; and
a focus detection element to:
determine a focus plane of the eye has deviated from the predetermined focus plane of the eye; and
adjust at least one of the first and second light beams based the determination that the focus plane of the eye has deviated from the predetermined focus plane of the eye.

23. The apparatus according to claim 22, wherein the focus detection element is to adjust a beam alignment of the at least one of the first and second light beams.

24. The apparatus according to claim 22, wherein the focus detection element is to adjust an alignment of the first light beam and an alignment of the second light beam.

25. The apparatus according to claim 22, wherein the focus detection element is to retrieve light beam adjustment information from a lookup table to adjust the at least one of the first and second light beams.
